(19) United States
(12) Patent Application Publication
(10) Pub. No.: US 2024/0309911 A1
(43) Pub. Date: Sep. 19, 2024

(54) ANGULAR BALL BEARING ARRANGEMENT

(71) Applicant: AKTIEBOLAGET SKF, Göteborg (SE)

(72) Inventors: Ingo SCHULZ, Gerolzhofen (DE); Lijun CAO, Houten (NL)

(21) Appl. No.: 18/576,604

(22) PCT Filed: Jul. 11, 2022
(86) PCT No.: PCT/EP2022/069282

§ 371 Date: Jan. 4, 2024

(30) Foreign Application Priority Data
Jul. 16, 2021 (DE) 102021207589.4

(51) Int. Cl. F16C 19/16; F16C 19/18; F16C 29/06; F16C 33/58

(52) U.S. Cl. CPC F16C 19/166; F16C 19/184; F16C 29/0638; F16C 33/585

(57) ABSTRACT

An angular contact ball bearing arrangement has first and second raceway elements having raceways and a plurality of balls therebetween. When viewed in cross section through one of the balls the arrangement is divided into first, second, third and fourth quadrants by an axis of rotation of one of the balls and a perpendicular axis perpendicular to the axis of rotation of the ball. Each ball has two contact points on each raceway that are offset from the perpendicular axis by #10 degrees, and the contacts points are each located in a different quadrant. Also the centre point of the radius curvature of the first raceway on one side of the perpendicular axis and the centre point of the radius of curvature of the first raceway on the other side of the perpendicular axis are in located in different quadrants.

The present invention relates to an angular contact ball bearing arrangement having a first raceway element and a second raceway element according to claim 1.

In high-precision gears, especially in the joints of robots or the bearings of wind turbine blades, a rotational movement of less than 360° at a low speed often has to be carried out by the bearings used there. At the same time, a complex load situation with both radial and axial forces, inclination torque loads and a combination of loads may occur here. Angular contact cylindrical roller bearings may be used for this purpose. However, cylindrical rollers which are arranged in an angled position in such a bearing do not show optimum rolling kinematics. As a result, in the case of cylindrical rollers, sliding, so-called slip, between the rollers and the raceway surfaces and between the roller side surfaces and the opposite raceway increases, resulting in increased wear. There is also sliding between the rollers themselves, which results in spacers being advantageous, which in turn increases the complexity of the bearing and entails additional effort in assembling the bearing. Sliding also leads to a high energy loss in such bearings. In addition, edge stress may occur in the case of angular contact cylindrical roller bearings, especially under high loads. Although said edge stress can be weakened by special profiles of the raceways, these are always only provided for an individual load situation and produce a poor load distribution in other load situations. The closer the load direction is to the axis of rotation of the roller, the less load is absorbed by the roller. This leads, under specific load conditions, to the load being supported only by 50% of the available rollers.

Another potential solution for absorbing both axial and radial loads is, for example, an angular contact ball bearing, in particular a double-row or two single-row angular contact ball bearings in an O or X arrangement. However, since there are only two contact points between the balls and the raceways in an angular contact ball bearing, this can lead to a high contact pressure. The two contact points between the balls and the raceways change with the load direction, which causes a dynamic change in the axis of rotation of the balls and therefore causes high and non-constant sliding and thus a high energy loss.

It is therefore the object of the present invention to provide a bearing arrangement which constitutes a stable bearing for radial and axial loads with a low energy loss and which is inexpensive and easy to produce.

This object is achieved by an angular contact ball bearing arrangement according to Claim 1.

The angular contact ball bearing arrangement has a first raceway element and a second raceway element, wherein balls are arranged between the raceway elements. The balls each roll along raceways, which are arranged on the raceway elements.

The raceways of the raceway elements are offset in relation to one another in the direction of the bearing axis of rotation. These offset raceways make it possible for combined loads, such as simultaneously acting radial and axial loads, to be absorbed. In particular, such an angular contact ball bearing can absorb forces, the lines of action of which are not precisely vertical, but instead run obliquely at an angle to the bearing axis of rotation.

The angular contact ball bearing arrangement can be a rotary bearing or a linear bearing. In the case of a rotary bearing, the first raceway element and the second raceway element correspond to the inner ring and the outer ring. In the case of a linear bearing, the first raceway element and the second raceway element correspond to a rail and a carriage.

In order to achieve low sliding and friction losses, as well as high bending rigidity and a low maximum contact pressure with the raceways, the balls each have four contact points with the raceways. This means that each ball has a total of four contact points, i.e. two contact points per raceway element. At the contact point, the respective raceway and the ball have the same tangent and the radius of curvature, i.e. the distance between the centre point of the circle of curvature of the raceway curvature and the contact point, is perpendicular to this tangent. These four contact points distribute the contact pressure in contrast to other bearings, and thereby reduce the contact stresses and thus the wear, the friction and other surface damage.

Conventional angular contact ball bearings only have two contact points, which results in a high contact pressure at these two contact points. In contrast, in the case of the angular contact ball bearing arrangement proposed here, four contact points are always active, which means that the contact pressure is better distributed.

In order to achieve this contact pressure distribution to the four contact points, the angular contact ball bearing arrangement is divided in cross section by the axis of rotation of a ball and an axis perpendicular to the axis of rotation of the ball theoretically into four quadrants arranged clockwise. The axis of rotation of the ball is considered here to be a theoretical axis of rotation at a standstill. During operation, the axis of rotation of the ball is not fixed, but rather can move. In contrast to ball bearings, such as deep groove ball bearings, the axis of rotation of the balls does not run perpendicular or parallel to the bearing axis of rotation, but rather obliquely at an angle to the bearing axis of rotation.

The raceway of the second raceway element lies in the first and the second quadrant and the raceway of the first raceway element lies in the third and the fourth quadrant. The centre point of the radius of curvature of the raceway of the first quadrant lies in the third quadrant, the centre point of the radius of curvature of the raceway of the second quadrant lies in the fourth quadrant, the centre point of the radius of curvature of the raceway of the third quadrant lies in the first quadrant, and the centre point of the radius of curvature of the raceway of the fourth quadrant lies in the second quadrant. Each of the four contact points of a ball lies in one of the four quadrants here. This special arrangement achieves the effect that each ball always has four contact points with its raceways and that these contact points are retained even under load. A conventional angular contact ball bearing works with only two contact points and angular contact cylindrical roller bearings also work only with two contact lines. The four contact points thus generate a lower contact pressure per contact point with the ball, as a result of which, for example, the wear of the angular contact ball bearing arrangement can be reduced, with radial and axial loads being able to be absorbed simultaneously by the arrangement of the contact points.

The use of balls can simplify the assembly of the angular contact ball bearing arrangement compared to an angular contact cylindrical roller bearing, since the balls, as compared to rollers, can be installed without any special orientation. The use of balls is furthermore advantageous, since a ball is a fully symmetrical element that does not require an alternating orientation of the rolling elements, as is known in the case of angular contact cylindrical roller bearings. This allows all of the rolling elements to carry the load between all of the raceways, even if they operate under specific conditions, rather than only half of the elements, as is the case with angular contact cylindrical roller bearings. Furthermore, balls can rotate freely about their centre and can therefore transfer the load over any point of their surface. This makes maximum use of the surface of the balls, distributes the contact over the entire ball surface and thus also distributes the wear over the entire ball surface. In contrast, for example, in the case of angular contact cylindrical roller bearings, only some regions of the rolling element surface would be worn.

The angular contact cylindrical ball bearing arrangement described here can be implemented as a full bearing without additional wear, as is the case with roller bearings, always taking place at the same position. The punctiform ball on ball contact does indeed cause wear of the balls. However, since the contact points “migrate” over the surface of the balls and thus the same point is not always loaded, this results in a lower overall load on the balls. This is the case since the orientation of the ball element with respect to the axis of rotation varies, in contrast to a roller bearing. Alternatively, a cage may also be used, with the use of spacers instead of a complete cage also being possible. The angular contact ball bearing arrangement provides enough space in the region along the ball axis of rotation to use both spacers and a cage.

According to one embodiment, the intersection of the two radii of curvature of the raceway of the first raceway element lies on an axis perpendicular to the axis of rotation of the ball, and the intersection of the two radii of curvature of the raceway of the second raceway element likewise lies on an axis perpendicular to the axis of rotation of the ball. These axes can also be a common axis, in particular the axis lying perpendicular to the axis of rotation and passing through the centre point of the ball. The intersections may also lie on the axis of rotation. Each raceway thus has two radii of curvature, the centre points of which do not coincide, as a result of which each raceway consists of two segments between which there is a transition. The transition between the two raceways or the contact line of the two raceways lies on a plane that passes through the ball centre point and is perpendicular to the imaginary ball axis of rotation. These two radii of curvature and their special arrangement can ensure that the ball always has four contact points with the raceways. The two radii of curvature can be different or identical.

According to another embodiment, the radii of curvature are identical. This results in a symmetrical distribution of the radii of curvature and their centre points between the four quadrants. This symmetrical arrangement distributes the load evenly across the four contact points between the balls and the raceways.

Owing to the special design in the form of an angular contact ball bearing, i.e. owing to the offset arrangements of the raceways of the raceway elements with respect to one another, the four quadrants are not divided symmetrically between the raceway elements. On the contrary, the four quadrants, and also the axis of rotation of the balls, are arranged obliquely with respect to the raceway elements and to the bearing axis of rotation.

According to a further embodiment, the contact points are arranged offset with respect to the axis perpendicular to the axis of rotation of the ball. This means that the contact points are preferably not located on the axis of rotation of the ball and on the axis perpendicular to the axis of rotation of the ball. This makes it possible to prevent the angular contact ball bearing arrangement from having only two contact points, which would reduce radial or axial rigidity. Furthermore, by means of the angular contact ball bearing arrangement, radial or axial loads can be absorbed in a defined manner directly from the start of the load, in contrast to a conventional angular contact ball bearing, which has in each case a contact point on one of the raceway elements, or a conventional ball bearing, which also has a contact point on one of the axes.

According to a further embodiment, the contact points are arranged in a range of ±20°, preferably ±10°, about the axis perpendicular to the axis of rotation of the ball. The contact points between the ball and the raceways may vary within this range depending on the application. By this arrangement, the four contact points create special kinematics of the balls, since the axis of rotation of the balls always remains perpendicular to the axis about which the contact points are arranged, even during a load. The contact points may be arranged symmetrically about the axis perpendicular to the axis of rotation of the ball, e.g. ±10° in both directions. Alternatively, the contact points may also be arranged asymmetrically about the axis perpendicular to the axis of rotation of the ball, e.g. ±10° and −5° or ±5° and −10°.

According to one embodiment, the radius of curvature is a variable radius. This means that the respective raceways can be circular arc segments, but also ellipses or ovals in general.

The angular contact ball bearing arrangement can be designed as a double-row angular contact ball bearing arrangement having a first and a second row of balls. By means of such a double-row configuration, axial loads in both directions can be absorbed by the angular contact ball bearing arrangement. The two rows can be arranged in an O or X arrangement. Depending on the configuration in question of the angular contact ball bearing arrangement, the intersection of the axes of rotation of the balls of the two rows can be arranged radially outside or radially within the raceway elements in relation to the axis of rotation of the bearing.

The first raceway element or the second raceway element can be designed as a divided raceway element for in each case the first and the second row of balls, and the second raceway element or the first raceway element can be designed as a common raceway element for the first and the second row of balls. In particular, a pretensioning mechanism can be provided to control the contact points between the ball and the raceways of the divided raceway element. By pretensioning the divided raceway element, the pretensioning of the contact points can be adjusted by adjusting the clearance between the parts of the divided raceway element.

Owing to the angular contact ball bearing arrangement described here, many different bearing configurations are thus possible, each showing the advantages of the angular contact ball bearing arrangement, as described above. In particular, the angular contact ball bearing arrangement described here provides good radial load rigidity and a low wear behaviour due to a low sliding behaviour, while both radial and axial loads can be absorbed simultaneously.

According to a further aspect, a gear, in particular a high-precision gear, is provided with an angular contact ball bearing arrangement as described above. Such a high-precision gear can be used, for example, in robots that require very precise control of the motion sequences and therefore of the joints in which bearings are used. The angular contact ball bearing arrangement can be used, for example, as a bearing in a robot application to connect successive arms or arm parts.

Further advantages and advantageous embodiments are specified in the description, the drawings and the claims. In particular, the combinations of the features specified in the description and in the drawings are purely exemplary here, and therefore the features can also be present individually or in other combinations.

In the following, the invention will be described in more detail using exemplary embodiments illustrated in the drawings. The exemplary embodiments and the combinations shown in the exemplary embodiments are purely exemplary here and are not intended to define the scope of protection of the invention. This is defined solely by the attached claims.

In the drawings:

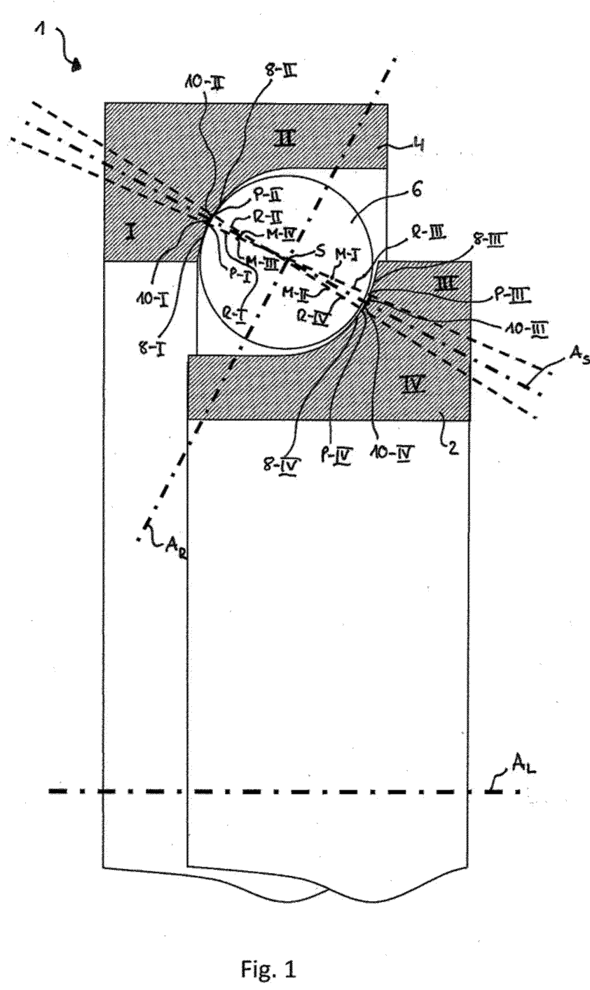

FIG. 1: shows a schematic cross-sectional view of an angular contact ball bearing arrangement;

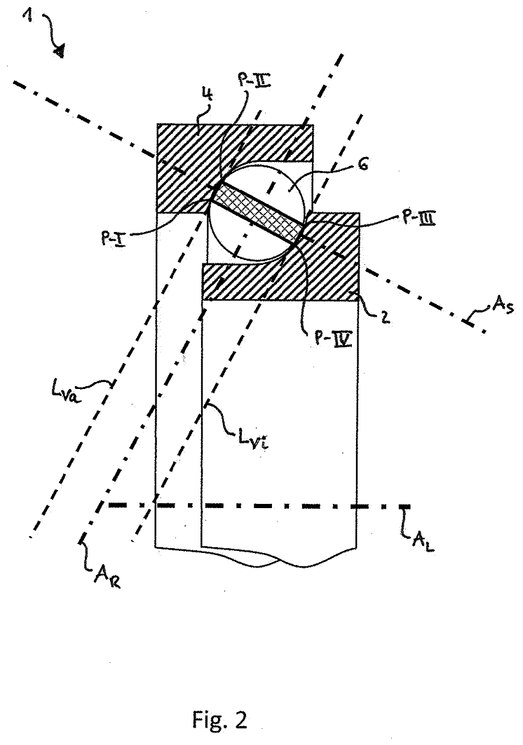

FIGS. 2-4: show schematic cross-sectional views of the angular contact ball bearing arrangement of FIG. 1 with differently arranged contact points;

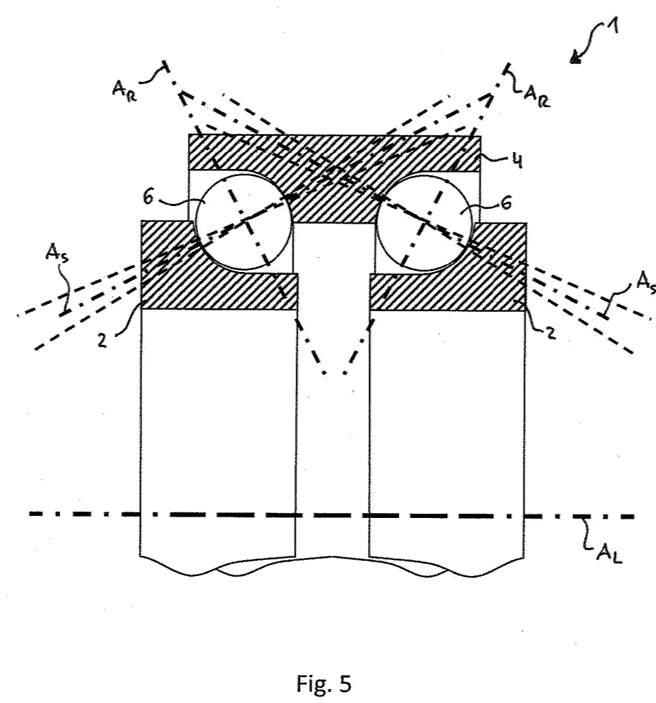

FIG. 5: shows a schematic cross-sectional view of the angular contact ball bearing arrangement of FIG. 1 as a double-row angular contact ball bearing arrangement in an O-arrangement;

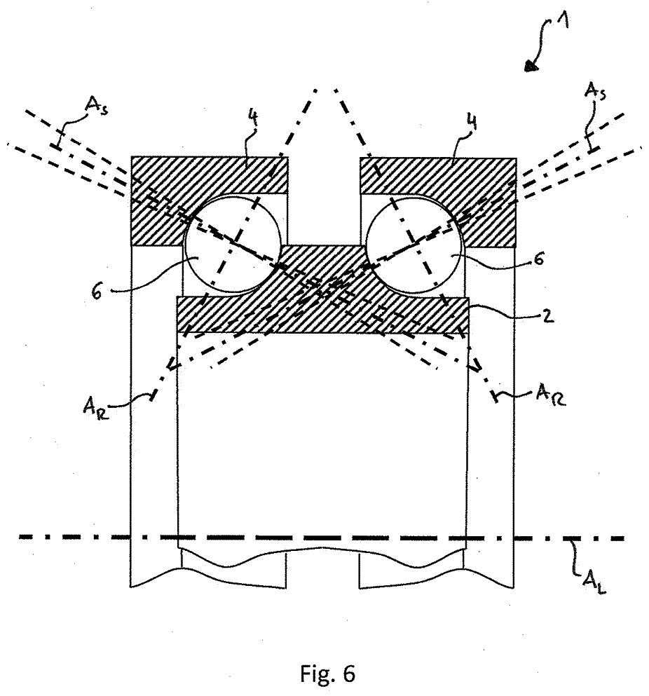

FIG. 6: shows a schematic cross-sectional view of the angular contact ball bearing arrangement of FIG. 1 as a double-row angular contact ball bearing arrangement in an X-arrangement; and

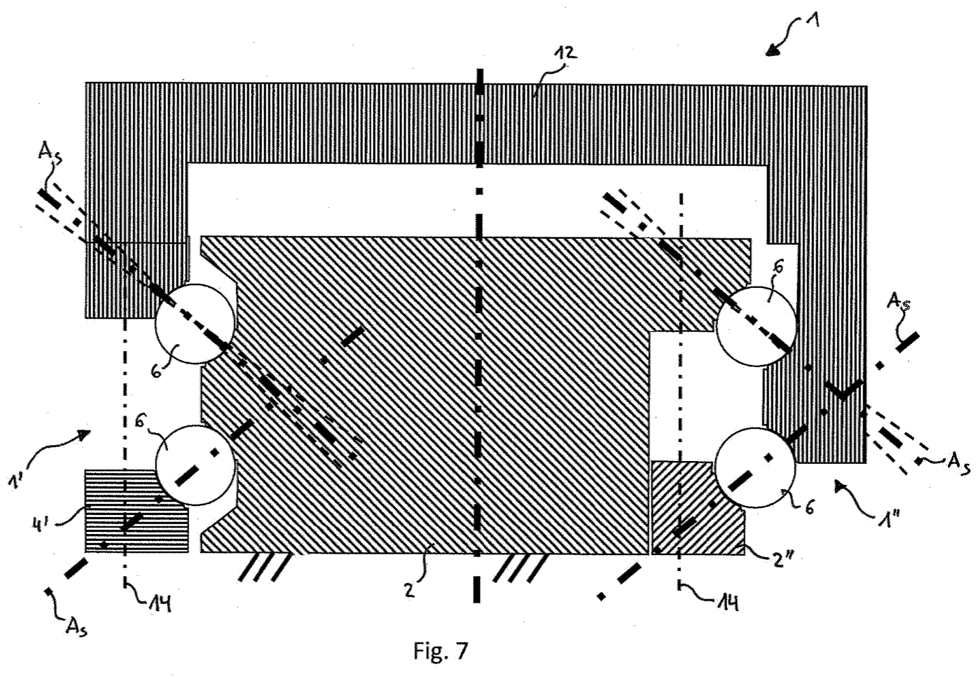

FIG. 7: shows a schematic cross-sectional view of the angular contact ball bearing arrangement of FIG. 1 as a linear bearing with a divided raceway element.

In the following, identical or functionally equivalent elements are identified by the same reference signs.

FIG. 1 shows an angular contact ball bearing arrangement 1 having a first raceway element 2 and a second raceway element 4. Balls 6 in the form of rolling elements are arranged between the raceway elements 2, 4. The balls 6 roll along raceways 8, which are arranged on the raceway elements 2, 4.

The angular contact ball bearing arrangement 1 can be designed as a rotary bearing or as a linear bearing. In the case of a rotary bearing, the first raceway element 2 and the second raceway element 4 correspond to the inner ring and the outer ring. In the case of a linear bearing, the first raceway element 2 and the second raceway element 4 correspond to the rail and the carriage.

In the case of the angular contact ball bearing arrangement 1 shown in FIG. 1, the raceways 8 can be theoretically divided into four quadrants I, II, III, IV. The division into the four quadrants I, II, III, IV is effected by the axis of rotation A_{R} of the ball and an axis A_{S} perpendicular to the axis of rotation A_{R}. The raceway of the second raceway element 4 is formed by two segments 8-I, 8-II and lies in the first and second quadrants I, II and the raceway of the first raceway element 2 is formed by two raceway segments 8-III and 8-IV and lies in the third and fourth quadrants III, IV. As can be seen, the four quadrants I, II, III, IV and the axis of rotation A_{R} of the ball are arranged obliquely with respect to the raceway elements 2, 4 and to the bearing axis of rotation A_{L}.

The ball 6 comes into contact with the raceways 8-I, 8-II at two contact points P-I, P-II located in two contact zones 10-I and 10-II, and with the raceways 8-III and 8-IV at two contact points P-III, P-IV located in the contact zones 10-III and 10-IV. To ensure that the ball 6 contacts the raceways 8 at the contact points P-I, P-II, P-III, P-IV, the raceways 8 have a special configuration: The centre point M-I of the radius of curvature R-I of the raceway segment 8-I lies in the third quadrant III, the centre point M-II of the radius of curvature R-II of the raceway segment 8-II lies in the fourth quadrant IV, the centre point M-III of the radius of curvature R-III of the raceway segment 8-III lies in the first quadrant I and the centre point M-IV of the radius of curvature R-IV of the raceway segment 8-IV lies in the second quadrant II.

In the embodiment shown in FIG. 1, the intersection of the radii of curvature R-I, R-II of the first and the second quadrant I, II lies on the axis A_{S} and the intersection of the radii of curvature R-III, R-IV of the third and the fourth quadrant III, IV also lies on the axis A_{S}. However, the intersection may also not lie on the axis A_{S}. The radius of curvature R here means the radius defining the curvature, i.e. the distance between the raceway 8 and the centre point M. In particular, as shown in FIG. 1, the straight line through M-I and M-III intersects the straight line through M-II and M-IV at the intersection S. In the case shown here, the intersection S simultaneously lies on the intersection of the axis of rotation A_{R} and the axis A_{S}, but this is not absolutely necessary. This specific configuration of the radii of curvature R of the raceways 8 ensures that the ball 6 contacts the raceways 8 at the contact points P-I, P-II, P-III, P-IV. The contact points P-I, P-II, P-III, P-IV are located in the contact zones 10 in a range of ±20°, in particular ±10° about the axis A_{S}.

To ensure that the angular contact ball bearing 1 can absorb not only axial or radial loads, the contact points P-I, P-II, P-III, P-IV are always offset with respect to the axis A_{S}. In this way, the ball 6 always has four contact points P-I, P-II, P-III, P-IV with the raceways 8, which are in each case located in the contact zones 10-I, 10-II, 10-III and 10-IV, as a result of which good radial load rigidity and a good load and pressure distribution and thus a low wear behaviour are achieved.

The exact arrangement of the contact points P-I, P-II, P-III, P-IV may differ, as shown in FIGS. 2 to 4.

In FIG. 2, the contact points P-I and P-II and also P-III and P-IV are arranged symmetrically about the axis A_{S}. The connecting line L_{Va} of the contact points P-I and P-II and the connecting line L_{Vi} of the contact points P-III and P-IV therefore run parallel to each other and parallel to the ball axis of rotation A_{R}. The region spanned by the connection of all of the contact points P-I, P-II, P-III and P-IV forms a rectangle.

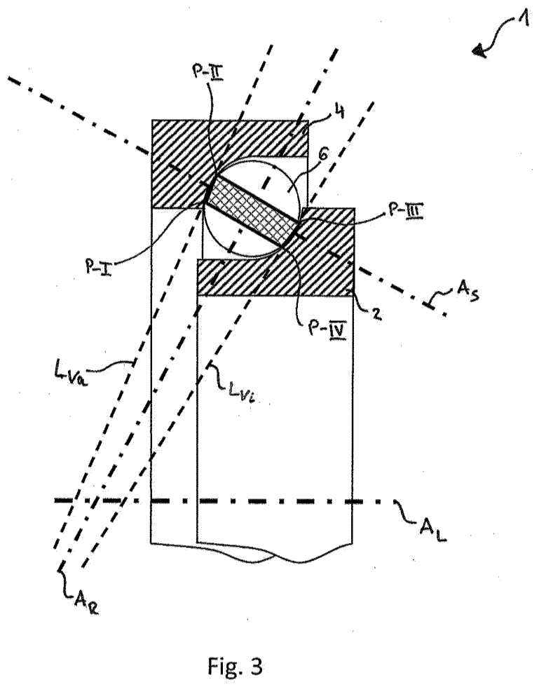

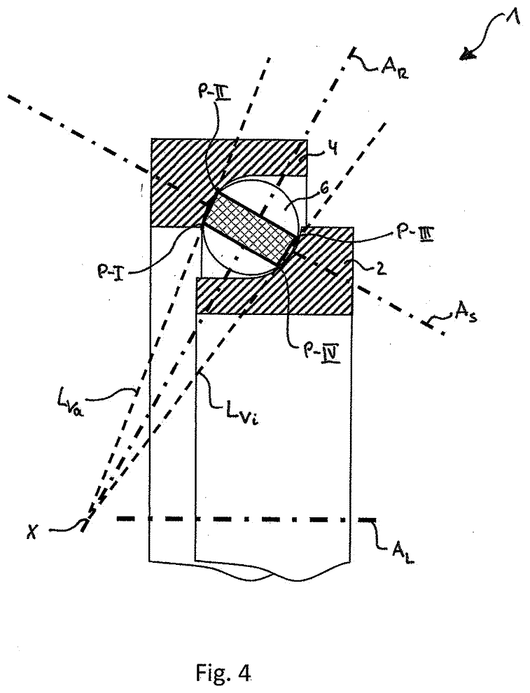

Alternatively, as shown in FIGS. 3 and 4, the contact points P-I and P-II and also P-III and P-IV are arranged asymmetrically about the axis A_{S}. The connecting line L_{Va} of the contact points P-I and P-II and the connecting line L_{Vi} of the contact points P-III and P-IV run obliquely with respect to each other and to the ball axis of rotation A_{R}. The region spanned by the connection of all of the contact points P-I, P-II, P-III and P-IV forms a trapezoid. The connecting lines L_{Va} and L_{Vi} may intersect, depending on the formation of the asymmetric arrangement. In FIG. 4, for example, the connecting line L_{Va} of the contact points P-I and P-II and the connecting line L_{Vi} of the contact points P-III and P-IV intersect at the intersection X, which lies on the bearing axis A_{L}.

By positioning the intersection X of the connecting lines L_{Va} and L_{Vi} above, on or below the bearing axis A_{L}, the rolling kinematics and the contact stresses of the angular contact ball bearing arrangement 1 can be optimized for different load profiles, e.g. for an operation which is as slip-free as possible, or for high power transmission, or both.

The angular contact ball bearing arrangement 1 can be used as a double-row angular contact ball bearing in an O arrangement (FIG. 5) or in an X arrangement (FIG. 6). In the case of the O arrangement, the axes of rotation A_{R} of the balls 6 intersect radially on the inside in the direction of the bearing axis of rotation A_{L}, and, in the case of the X arrangement, the axes of rotation A_{R} of the balls 6 intersect radially on the outside.

In the case of such a double-row angular contact ball bearing, the inner or outer rings 2, 4 can be designed as divided rings. In the case of the O arrangement of FIG. 5, the inner ring 2 is designed as a divided ring. In the case of the X arrangement of FIG. 6, the outer ring 4 is designed as a divided ring. In this case, a pretensioning mechanism, for example a screw connection, can be used to control the contact points P-I, P-II, P-III, P-IV or contact zones 10 between the ball 6 and the raceways 8. By pretensioning the respective ring 2, 4, the pretensioning of the contact points P-I, P-II, P-III, P-IV can be adjusted by adjusting the clearance between the parts of the divided ring 2, 4.

The angular contact ball bearing arrangement 1 can also be used as a linear bearing, as is illustrated in FIG. 7. Here, the angular contact ball bearing arrangement 1 is formed by two double-row angular contact ball bearing arrangements l′ and 1″.

For the angular contact ball bearing arrangement 1′, the first raceway element 2 is formed by a rail with raceways for both rows of balls 6 and the second raceway element by a carriage 12 and an element 4′ separate therefrom, i.e. as a divided raceway element 4. For the angular contact ball bearing arrangement 1″, the first raceway element 2 is also formed by the rail and additionally by an element 2″ separate therefrom, i.e. as a divided raceway element 2, and the second raceway element is formed by the carriage 12 with raceways for the two rows of balls 6.

In this case too, the divided raceway elements 2″ and 4′ can be adjusted by a pretensioning element 14 in their pretensioning or their clearance, in order to correspondingly adjust the contact points P-I, P-II, P-III, P-IV or the contact zones 10-I, 10-II, 10-III, 10-IV.

Owing to the angular contact ball bearing described here, good radial and axial load rigidity and a low wear behaviour because of lower friction can be achieved.

### LIST OF REFERENCE SIGNS

1 angular contact ball bearing arrangement
2 first raceway element
4 second raceway element
6 balls
8 raceways
10 contact zones
12 carriage
14 pretensioning mechanism
I, II, III, IV quadrants
A_{L} bearing axis of rotation
A_{R} ball axis of rotation
A_{S} axis perpendicular to the ball axis of rotation
L_{Va} connecting line of the contact points
L_{Vi} connecting line of the contact points
M centre point of the radius of curvature
P contact points
R radius of curvature
S intersection
X intersection

1. An angular contact ball bearing arrangement having comprising: a first raceway element having a first raceway,
a second raceway element having a second raceway, and
a plurality of balls between the first raceway element and the second raceway element in contact with the first and second raceways,
wherein, when viewed in cross section through one ball of the plurality of balls the angular contact ball bearing arrangement is divided into a first quadrant, a second quadrant, a third quadrant and a fourth quadrant arranged clockwise by an axis of rotation of the one ball and an axis perpendicular to the axis of rotation of the one ball,
wherein the one ball contacts the second raceway at a first contact point in the first quadrant and a second contact point in the second quadrant and contacts the first raceway at a third contact point in the third quadrant and a fourth contact point in the fourth quadrant,
wherein the second raceway lies in the first quadrant and in the second quadrant and the first raceway lies in the third quadrant and in the fourth quadrant,
wherein a centre point of a radius of curvature of a portion of the second raceway in the first quadrant lies in the third quadrant,
wherein a centre point of a radius of curvature of a portion of the second raceway in the second quadrant lies in the fourth quadrant,
wherein a centre point of a radius of curvature of a portion of the first raceway in the third quadrant lies in the first quadrant,
wherein a centre point of a radius of curvature of a portion of the first raceway in the fourth quadrant lies in the second quadrant,
wherein the first contact point and the second contact point are offset from the axis perpendicular to the axis of rotation of the one ball and lie on the second raceway within an angle of ±10° from the axis perpendicular to the axis of rotation of the one ball, and
wherein the third contact point and the fourth contact point are offset from the axis perpendicular to the axis of rotation of the one ball and lie on the first raceway within an angle of ±10° from the axis perpendicular to the axis of rotation of the one ball.

2. The angular contact ball bearing arrangement according to claim 1, wherein the radius of curvature of the portion of the second raceway in the first quadrant and the radius of curvature of the portion of the second raceway in the second quadrant intersect on the axis perpendicular to the axis of rotation of the one ball, and
wherein the radius of curvature of the portion of the first raceway in the third quadrant and the radius of curvature of the portion of the first raceway in the fourth quadrant intersect on the axis perpendicular to the axis of rotation of the one ball.

3. The angular contact ball bearing arrangement according to claim 2, wherein the radius of curvature of the portion of the second raceway in the first quadrant and the radius of curvature of the portion of the second raceway in the second quadrant and the radius of curvature of the portion of the first raceway in the third quadrant and the radius of curvature of the portion of the first raceway in the fourth quadrant are identical.

4-5. (canceled)

6. The angular contact ball bearing arrangement according claim 1, wherein the radius of curvature of the portion of the second raceway in the first quadrant and the radius of curvature of the portion of the second raceway in the second quadrant and the radius of curvature of the portion of the first raceway in the third quadrant and the radius of curvature of the portion of the first raceway in the fourth quadrant are non-constant.

7. The angular contact ball bearing arrangement according to claim 1, wherein the angular contact ball bearing arrangement is a double-row angular contact ball bearing arrangement and wherein the plurality of balls include a first row of the plurality of balls and a second row of the plurality of balls.

8. The angular contact ball bearing arrangement according to claim 7, wherein the first raceway element or the second raceway element is configured as a divided raceway element, and
wherein the second raceway element or the first raceway element is configured as a common raceway element.

9. The angular contact ball bearing arrangement according to claim 8, including a preloading mechanism for controlling the first, second, third and fourth contact points.

10. The angular contact ball bearing arrangement according to claim 1, wherein the angular contact ball bearing arrangement is a linear bearing,
wherein the first raceway element is a rail and
wherein the second raceway element is a carriage.

11. The angular contact ball bearing according to claim 1,
wherein the first contact point is located in the first quadrant and the second contact point is located in the second quadrant and the third contact point is located in the third quadrant and the fourth contact point is located in the fourth quadrant.
